(19) United States
(12) Patent Application Publication
(10) Pub. No.: US 2007/0090872 A1
(43) Pub. Date: Apr. 26, 2007

(54) Capacitance multiplier circuit for PLL filter

(76) Inventors: Yu-Chen Chen, Taipei (TW); Yao-Chun Lu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/253,673

(22) Filed: Oct. 20, 2005

(51) Int. Cl. G06G 7/28

(52) U.S. Cl. 327/552; 327/334

(57) ABSTRACT

A capacitance multiplier circuit for a filter is provided. The capacitance multiplier circuit capable of adjusting its equivalent capacitance and used in the filter, applied to a Phase Locked Loops (PLLs) circuit, includes a first operational amplifier having a positive input end for receiving an input signal, an output end, and a negative input end connected to the output end, a second operational amplifier having a positive input end, a negative input end connected to the output end of the first operational amplifier through a first resistor, and an output end connected to the negative input end through a second resistor, and a capacitor connected between the positive input end of the first operational amplifier and the output end of the second operational amplifier. An equivalent capacitance of the capacitance multiplier circuit is adjusted by configuring the ratio of the first resistor and the second resistor.

### BAKCGROUND OF THE INVENTION

1. Field of the Invention

The present invention relates to a capacitance multiplier circuit for a filter, and more particularly, to a capacitance multiplier circuit for substituting any given large capacitance capacitor in a Phase Locked Loops (PLLs) circuit.

2. Description of Prior Arts

PLLs is widely used in numerous integrated circuit designs for the purpose, for example, of integrating timing signals, restoring the timing information from the data stream, or combining frequencies. The built-in PLLs inside a large digital system naturally creates the space use problem, especially when numerous PLLs are placed into a single chip.

Prior arts generally employed passive devices such as resistors or capacitors to implement the filter-use PLLs. However, the use of passive devices (especially the use of capacitors) takes a significant part of the chip layout. Even some alternatives to the implement of capacitors have been proposed, they are not close to being ideal when it comes to unit-capacitance rate of these capacitors.

Please refer to FIG. 1 of a circuit diagram of a prior art second-order filter used in the PLLs. A resistor R₁₀₀ serially connects to a capacitor C₁₀₀ and this R-C pair further connects to C₁₀₁ in a parallel manner, in order to form the second-order filter. Generally, in this typical second-order filter the capacitance of C₁₀₀ is much larger than that of C₁₀₀ (for example, C₁₀₀ could be twenty times larger than C₁₀₁). Simply because of the use of capacitors C₁₀₀ and C₁₀₁, as long as more and more second-order filters are going to be placed the entire space that PLLs would occupy increases accordingly, creating some disadvantages to layout of the corresponding integrated circuit design.

Please refer to Fig.2 of a circuit diagram showing a prior art third-order filter. Compared to above second-order filter, only the resistor R₂₀₁ and the capacitor C₂₀₃ are newly added. Like above second-order filter, capacitance of the capacitor C₂₀₀ is much larger than that of the capacitor C₂₀₁ while the capacitance of the capacitor C₂₀₃ is even larger than that of the capacitor C₂₀₀, suggesting much more space is necessary for the third-order filter circuit and consequently PLLs employing the third-order filter circuit would require much more space than its counterpart using the second-order filter.

### SUMMARY OF THE INVENTION

It is therefore a primary objective of the present invention to provide a capacitance multiplier circuit for a PLL filter in order to simplify the layout of capacitors for the purpose of reducing the layout space typical capacitors would occupy.

In accordance with the claimed invention, a capacitance multiplier circuit for a filter, applied to a Phase Locked Loops (PLLs) circuit, includes a first operational amplifier having a positive input end for receiving an input signal, an output end, and a negative input end connected to the output end, a second operational amplifier having a positive input end, a negative input end connected to the output end of the first operational amplifier through a first resistor, and an output end connected to the negative input end through a second resistor, and a capacitor connected between the positive input end of the first operational amplifier and the output end of the second operational amplifier. The equivalent capacitance of above circuit would be adjusted by configuring the ratio of the first resistor and the second resistor, in order to substitute typical large capacitance capacitors for reducing the layout space they would occupy.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram showing a prior art second-order filter.

FIG. 2 is a circuit diagram showing a prior art third-order filter.

FIG. 3 is a circuit diagram showing the present invention capacitance multiplier circuit.

FIG. 4 is a circuit diagram showing a preferred embodiment second-order filter incorporating the present invention capacitance multiplier circuit.

FIG. 5 is a block diagram showing a preferred embodiment phase locked loops circuit incorporating the present invention capacitance multiplier circuit.

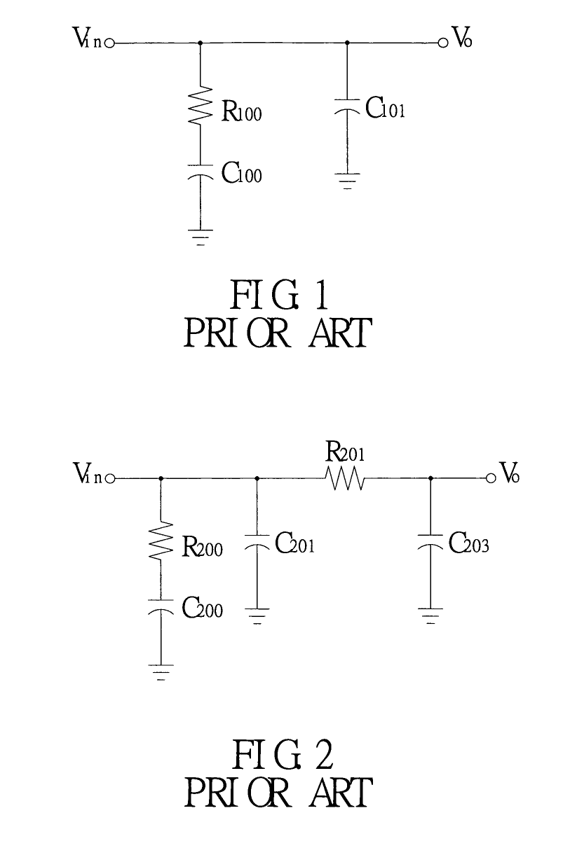

### DETAILED DESCRIPTION OF THE PREFERRED EMBODIMENT

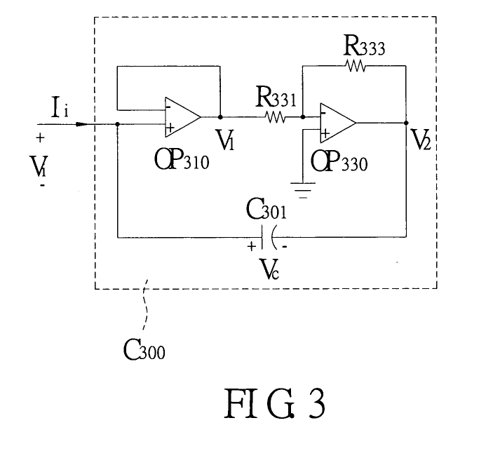

Please refer to FIG. 3 of a circuit diagram showing a capacitance multiplier circuit according to the present invention. The first operational amplifier OP₃₁₀ includes one positive input end, one negative input end connected to the positive input end thereof that receives the input voltage Vᵢ and input current Iᵢ. The second operational amplifier OP₃₃₀ includes one positive input end, one negative input end, and one output end connected to the negative input end thereof through a resistor R₃₃₃ A capacitor C₃₀₁ includes a positive end connected to the positive input end of the first operational amplifier OP₃₁₀ and a negative end thereof connected to the output end of the second operational amplifier OP₃₃₀. By doing so, the capacitance of the capacitor C₃₀₁ could be increased by first and second operational amplifiers OP₃₁₀ and OP₃₃₀ at the rate configured by the ratio of resistors R₃₃₁ and R₃₃₃, so as to have an equivalent capacitance C₃₀₀ for the entire capacitance multiplier circuit.

Because the input voltage Vᵢ is inputted into the positive input end of the first operational amplifier OP₃₁₀, the output voltage V₁ of the first operational amplifier OP₃₁₀ is equal to the input voltage Vᵢ thereof. The second operational amplifier OP₃₃₀ is an inverse amplifier and its output voltage V₂ could be represented as follows: V₂=−(R₃₃₃/R₃₃₁)×V₁. Since the output voltage of the first operational amplifier V₁ is equal to the input voltage Vᵢ thereof, meaning above equation could be rewritten as V₂=−(R₃₃₃/R₃₃₁)×Vᵢ, meaning the input voltage Vᵢ could be increased by configuring the ratio between resistors R₃₃₃ and R₃₃₁ As the result, the voltage drop V_{C} across the capacitor C₃₀₁ is the product of the input current Iᵢ and the impedance of the capacitor C₃₀₁, which could be represented as V_{C}=Iᵢ×(SC₃₀₁)⁻¹ wherein S represents any given frequency.

From the standpoint of node voltage, the capacitor voltage drop V_{C} is equal to the output voltage V₁ of the first operational amplifier OP₃₁₀ plus the output voltage V₂ of the second operational amplifier OP₃₃₀. Further because the output voltage V₁ of the first operational amplifier OP₃₁₀ is equal to the input voltage Vᵢ thereof, another equation Vᵢ+(R₃₃₃/R₃₃₁)×Vᵢ=Iᵢ×(SC₃₀₁)⁻¹ would follow. With above equation, the impedance of the entire circuit of the present invention would be Vᵢ/Iᵢ=(SC₃₀₁×(1+R₃₃₃/R₃₃₁))⁻¹ and the equivalent capacitance C₃₀₀ is equal to C₃₀₁×(1+R₃₃₃/R₃₃₁). The equivalent capacitance C₃₀₀ is the product of capacitance C₃₀₁ and (1+R₃₃₃/R₃₃₁), meaning the equivalent capacitance could be adjusted by setting the ratio of second resistors R₃₃₃ and R₃₃₁ despite the capacitor C₃₀₁ is merely a small capacitance capacitor. As long as the capacitor C₃₀₁ is a relatively small capacitance capacitor, the corresponding circuit layout for the capacitor could be reduced accordingly.

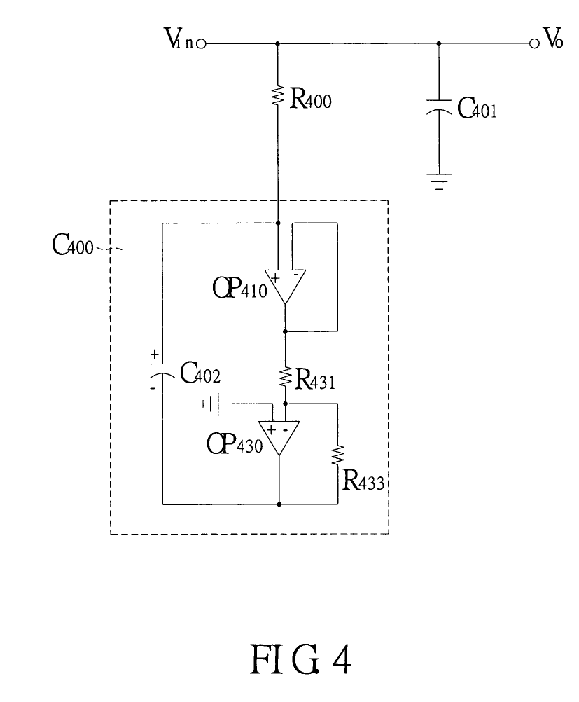

Please refer to FIG. 4 of a circuit diagram of a preferred embodiment according to the present invention used in the second-order filter circuit. In conjunction with FIG. 1 of a prior art second-order filter, the equivalent capacitance C₄₀₀ of the circuit capable of adjusting its equivalent capacitance based on the present invention substitutes the capacitor C₁₀₀ shown in FIG. 1 wherein the equivalent capacitance C₄₀₀ comes from the combination of operational amplifiers, resistors, and capacitors. Because areas occupied by operational amplifiers and resistors are relatively small and the capacitor C₄₀₂ in the present circuit, like another parallel capacitor C₄₀₁, is of a small capacitance could be increased by operational amplifiers OP₄₁₀ and OP₄₃₀ at the rate of the configurable ratio of resistors R₄₃₃ and R₄₃₁, in order to form the equivalent capacitance C₄₀₀. The entire circuit with such equivalent capacitance C₄₀₀ takes smaller layout space than the large capacitance capacitor C₁₀₀ did. Wherein the positive input end of the second operational amplifier OP₄₃₀ is AC ground.

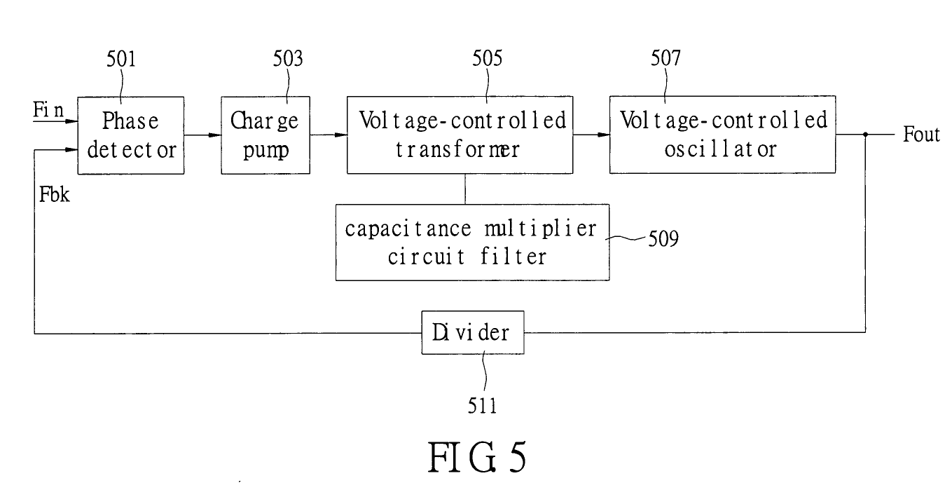

Please refer to FIG. 5 of a block diagram showing a phase locked loops circuit (PLLs) incorporating the present invention capacitance multiplier circuit. PLLs is a circuit for generating an output signal with the synchronous frequency and phase of an input signal. A signal outputted by an voltage controlling oscillator 507 is further divided by a divider 511, so as to form a feedback pulse signal F_{bk}, and an input reference pulse Fᵢₙ are both received by a phase detector 501 for generating a signal proportional to the phase difference between the input reference pulse Fᵢₙ and the feedback pulse signal F_{bk}. A charge pump 503 charges up the signal representing the phase difference between F_{bk} and Fᵢₙ and sends the charged-up signal to a voltage-controlled transformer 505, which further transmits the signal to a capacitance multiplier circuit filter 509, whose primary task is to remove the AC part of the signal. As the result, a DC signal would be provided to a voltage-controlled oscillator 507 for outputting an output frequency Fₒᵤₜ. The function of the capacitance multiplier circuit filter 509 and the phase detector 510 is for minimizing the output errors of the voltage-controlled oscillator 507. Generally speaking, the circuit filter would be the primary part of the entire PLLs layout, but with the present invention eliminating the use of large capacitance capacitors in the circuit filter and replacing them with the present invention capacitance multiplier circuit, the entire PLLs layout would be more simplified.

With the number of PLLs applications significantly increase in state-of-art communication systems, electro-optical systems, and computer systems, the incorporation of the present invention reduces the entire size of PLLs circuits and facilitates the efficient use of layout space in integrated circuit.

Those skilled in the art will readily observe that numerous modifications and alterations of the device may be made while retaining the teachings of the invention. Accordingly, the above disclosure should be construed as limited only by the metes and bounds of appended claims.

What is claimed is:

1. A capacitance multiplier circuit for a filter, applied to a phase locked loops (PLLs) circuit, comprising:
a first operational amplifier having a positive input end for receiving an input signal, an output end, and a negative input end connected to the output end;
a second operational amplifier having a positive input end, a negative input end connected to the output end of the first operational amplifier through a first resistor, and an output end connected to the negative input end through a second resistor; and
a capacitor connected between the positive input end of the first operational amplifier and the output end of the second operational amplifier;
thereby adjusting an equivalent capacitance of the capacitance multiplier circuit by configuring the ratio of the first resistor and the second resistor.

2. The capacitance multiplier circuit in claim 1 wherein the value of the equivalent capacitance represented as follows: Ceq=Cx(1+R₂/R₁), wherein Ceq is the value of the equivalent capacitance, C is the value of the capacitor, R₂ is the value of the second resistor, and R₁ is the value of the first resistor.

3. The capacitance multiplier circuit in claim 1 wherein the positive end of the capacitor connects to the positive input end of the first operational amplifier and the negative end of the capacitor connects to the output end of the second operational amplifier.

4. The capacitance multiplier circuit in claim 1 is applied to a phase locked loops (PLLs) circuit in a communication system.

5. The capacitance multiplier circuit in claim 4 is for substituting any large capacitance capacitor in the PLLs circuit in order to save the size of the layout of the PLLs.

6. The capacitance multiplier circuit in claim 1 is applied to a phase locked loops (PLLs) circuit in an optical-electro system.

7. The capacitance multiplier circuit in claim 6 is for substituting any large capacitance capacitor in the PLLs circuit in order to save the size of the layout of the PLLs.

8. The capacitance multiplier circuit in claim 1 is applied to a phase locked loops (PLLs) circuit in a computer system.

9. The capacitance multiplier circuit in claim 8 is for substituting any large capacitance capacitor in the PLLs in order to save the size of the layout of the PLLs.
